(19) United States
(12) Patent Application Publication
(10) Pub. No.: US 2013/0325703 A1
(43) Pub. Date: Dec. 5, 2013

(54) SYSTEMS, METHODS, AND COMPUTER PROGRAM PRODUCTS FOR MEMBERSHIP PROGRAM MANAGEMENT

(71) Applicant: BLACKBAUD, INC., (US)

(72) Inventors: George Alexander Kingsley, Harleyville, SC (US); Nathan Philip Renihan, Hanahan, SC (US); Patricia Ann Mulligan, Mt. Pleasant, SC (US); Carolyn Marie Davy, Charleston, SC (US)

(73) Assignee: BLACKBAUD, INC., Charleston, SC (US)

(21) Appl. No.: 13/784,483

(22) Filed: Mar. 4, 2013

Related U.S. Application Data
(60) Provisional application No. 61/642,991, filed on May 4, 2012.

(51) Int. Cl. G06Q 20/22

(52) U.S. Cl. CPC G06Q 20/22
USPC 705/39

(57) ABSTRACT

The invention is directed to systems, methods and computer program products for managing membership programs. An exemplary method for establishing a membership program comprises: receiving selection of whether the membership program is annual, recurring, or lifetime; receiving selection of whether the membership program is dues-based, contribution-based, or both dues-based and contribution-based; and receiving selection of whether the membership program has a single term or multiple terms. An exemplary method for processing a payment associated with a membership account includes the steps of receiving a payment, the payment representing at least one of a contribution associated with a contribution-based membership account or dues associated with a dues-based membership account; receiving information associated with a payor of the payment amount; receiving information associated with the membership account; and processing the payment based at least partially on the information associated with the payor and the membership account.

### BACKGROUND

Membership organizations often have varying membership models. The purpose or intent behind each membership model is different. For example, in a “cause-model,” the donor is given an opportunity to contribute in order to get a tax deduction and updates concerning a specific cause, wherein the donation goes to support the cause. In this model, the member may not get a benefit from the contribution. Examples of membership organizations that utilize a “cause-model” include environmental organizations, etc.

Another model often used by membership organizations is the “event-model.” Under the event-model model, donors pay to get the benefit to come to an event or be part of or affiliated with the organization. Donations under this model are typically dues-based, wherein the donation goes to support the organization. Because the members get a benefit, some or all of the donation may not be tax deductible.

There is a need for a system and method that supports both membership models. Additionally, there is a need for a system and method that: allows for an end-user configuration interface or wizard that manages complex membership programs; allows for data entry that supports complex transactions in a convenient, logical and non-labor intensive manner; does not require further coding or programming effort on the part of the user; is scalable without additional programming costs; enables the user to track the success of membership programs, including enabling the user to generate reports; facilitates customer service to the members of the membership programs, etc.

### BRIEF SUMMARY

Embodiments of the invention are directed to systems, methods and computer program products for managing membership programs.

In some embodiments, a method for establishing a membership program is provided. The method comprises: receiving selection of whether the membership program is annual, recurring, or lifetime; receiving selection of whether the membership program is dues-based, contribution-based, or both dues-based and contribution-based; receiving selection of whether the membership program has a single term or multiple terms; and receiving selection of at least one level associated with the membership program, wherein a dues-based membership program is program where a member makes a payment to achieve a level associated with the program, and wherein a contribution-based membership program is a program where a member is awarded a level associated with the program based on the member's amount of contribution.

In some embodiments, the method further comprises receiving selection of at least one benefit associated with the at least one level.

In some embodiments, the method further comprises receiving an expiration date associated with a renewal period for renewing a membership account associated with the membership program when the membership program is a recurring program.

In some embodiments, the method further comprises receiving selection of at least one condition for achieving the at least one level associated with the membership program, wherein the at least one condition includes an amount of dues or contribution to achieve or be awarded the at least one level.

In some embodiments, when the membership program is contribution-based, a pre-existing database of contributors can be inducted into the membership program based at least partially on whether a contributor in the pre-existing database satisfies at least one condition associated with being awarded the at least one level.

In some embodiments, a system for establishing a membership program is provided. The system comprises: a memory; a processor; and a module stored in the memory, executable by the processor, and configured to perform the various steps of the method described herein.

In some embodiments, a computer program product for establishing a membership program is provided. The computer program product comprises a non-transitory computer-readable medium comprising code configured to perform the various steps of the method described herein.

In some embodiments, a method for processing a payment associated with a membership account is provided. The method comprises receiving a payment, the payment representing at least one of a contribution associated with a contribution-based membership account or dues associated with a dues-based membership account; receiving information associated with a payor of the payment amount; receiving information associated with the membership account, the information associated with the membership account comprising whether the membership account is at least one of a contribution-based membership account or a dues-based membership account; and processing the payment based at least partially on the information associated with the payor and the information associated with the membership account.

In some embodiments, the information associated with the membership account further comprises at least one of a name, a level, a term, or an expiration date.

In some embodiments, the payment amount is for at least one of a full payment for an entire term of the membership account, a first installment of the full payment, or a payment associated with an installment plan.

In some embodiments, the method further comprises in response to the payment amount being a first installment or a payment associated with an installment plan, receiving an installment plan schedule, the installment plan schedule comprising a frequency, a start date, and a number of installments.

In some embodiments, the payment amount is a renewal amount.

In some embodiments, the method further comprises receiving selection of whether the membership account is a gift membership account; and in response to determining the membership account is a gift membership account, receiving information associated with an entity or person receiving the gift membership account.

In some embodiments, the membership program is at least one of an annual program, a recurring program, or a lifetime program.

In some embodiments, the processing step further comprises applying a discount to the payment amount.

In some embodiments, the method further comprises receiving at least one add-on, and wherein the processing step further comprises processing the payment based at least partially on the add-on.

In some embodiments, the method further comprises receiving information associated with at least one member to be included in the membership account, wherein the processing step further comprises processing the step based on the received information; and preventing inclusion of more than a predetermined number of members to the membership account.

In some embodiments, the method further comprises receiving selection of which members on the membership account should receive a membership card.

In some embodiments, the method further comprises receiving information regarding whether a member associated with the membership account is making a donation.

In some embodiments, the method further comprises receiving selection of a payment method, and wherein the processing step further comprises processing the payment based on the payment method.

In some embodiments, the method further comprises receiving selection of whether the payment should be acknowledged or whether the payor intends to remain anonymous.

In some embodiments, a system for processing a payment associated with a membership account is provided. The system comprises: a memory; a processor; a module stored in the memory, executable by the processor, and configured to: receive a payment, the payment representing at least one of a contribution associated with a contribution-based membership account or dues associated with a dues-based membership account; receive information associated with a payor of the payment amount; receive information associated with the membership account, the information associated with the membership account including whether the membership account is at least one of a contribution-based membership account or a dues-based membership account; and process the payment based at least partially on the information associated with the payor and the information associated with the membership account.

In some embodiments, a computer program product for processing a payment associated with a membership account is provided. The computer program product comprises a non-transitory computer-readable medium comprising code configured to: receive a payment, the payment representing at least one of a contribution associated with a contribution-based membership account or dues associated with a dues-based membership account; receive information associated with a payor of the payment amount; receive information associated with the membership account, the information associated with the membership account including whether the membership account is at least one of a contribution-based membership account or a dues-based membership account; and process the payment based at least partially on the information associated with the payor and the information associated with the membership account.

### BRIEF DESCRIPTION OF THE DRAWINGS

Having thus described embodiments of the invention in general terms, reference will now be made to the accompanying drawings, where:

FIGS. 1-9 and 12 are exemplary user interfaces for managing membership programs and executing various processes associated with membership programs, in accordance with embodiments of the present invention;

FIG. 10 is an exemplary block diagram of the system environment for managing membership programs and executing various processes associated with membership programs, in accordance with embodiments of the present invention; and

FIG. 11 is an exemplary process flow for processing a payment associated with a membership account, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Organizations need to manage their membership programs. The present invention provides a system that: allows for an end-user configuration interface or wizard that manages complex membership programs; allows for data entry that supports complex transactions in a convenient, logical and non-labor intensive manner; does not require further coding or programming effort on the part of the user; is scalable without additional programming costs; enables the user to track the success of membership programs, including enabling the user to generate reports; facilitates customer service to the members of the membership programs, etc. As used herein, an organization may be a profit or non-profit organization. Additionally, as used herein, an organization may also be referred to as an entity. Additionally, as used herein, the terms “data” and “information” may be used interchangeably.

Prior to the present invention, the event-model was the only model supported by relationship management programs. Embodiments of the present invention are directed to supporting both the cause-model-based and event-model-based membership models. In some embodiments, an interface is provided that queries the user for certain predetermined information in order to assist the user in developing a relationship management tool to support either the cause-model or the event-model approach, or both. This interface is based on parameter-driven logic that allows the user to configure a membership management program and all of the complexities that are associated with the membership program, e.g., prices, discounts, add-ons, levels, benefits, renewal windows, etc. As used herein, a user of the system may be an employee of the organization who has access to membership data associated with membership accounts. As used herein, a member may be a person or organization associated with a membership account. In some embodiments, the person or organization associated with a membership account may also have payment responsibility (e.g., of dues or contributions) associated with the account. In other embodiments, a different person or organization may have the payment responsibility associated with the membership account.

The present invention also enables the user to effectively communicate with members by segmenting the members based on account renewal rules configured by the user and then enables the user to track the responses from the members, thereby providing organizations a way to market and promote certain membership programs or levels within a membership program. The present invention also tracks benefit and fulfillment data by providing first class fields and an application programming interface (API) connector to integrate with third-party fulfillment vendors. Additionally, the present invention provides methods and systems that can create new membership programs or modify existing membership programs associated with a pre-existing database of donors and/or contributors or associated with new donors and/or contributors.

In some embodiments, an exemplary method for establishing a membership program comprises receiving selection of whether the membership program is annual, recurring, or lifetime; receiving selection of whether the membership program is dues-based, contribution-based, or both dues-based and contribution-based; and receiving selection of whether the membership program has a single term or multiple terms. In some embodiments, an exemplary method for processing a payment associated with a membership account comprises receiving a payment, the payment representing at least one of a contribution associated with a contribution-based membership account or dues associated with a dues-based membership account; receiving information associated with a payor of the payment amount; receiving information associated with the membership account, the information associated with the membership account including whether the membership account is at least one of a contribution-based membership account or a dues-based membership account; and processing the payment based at least partially on the information associated with the payor and the information associated with the membership account.

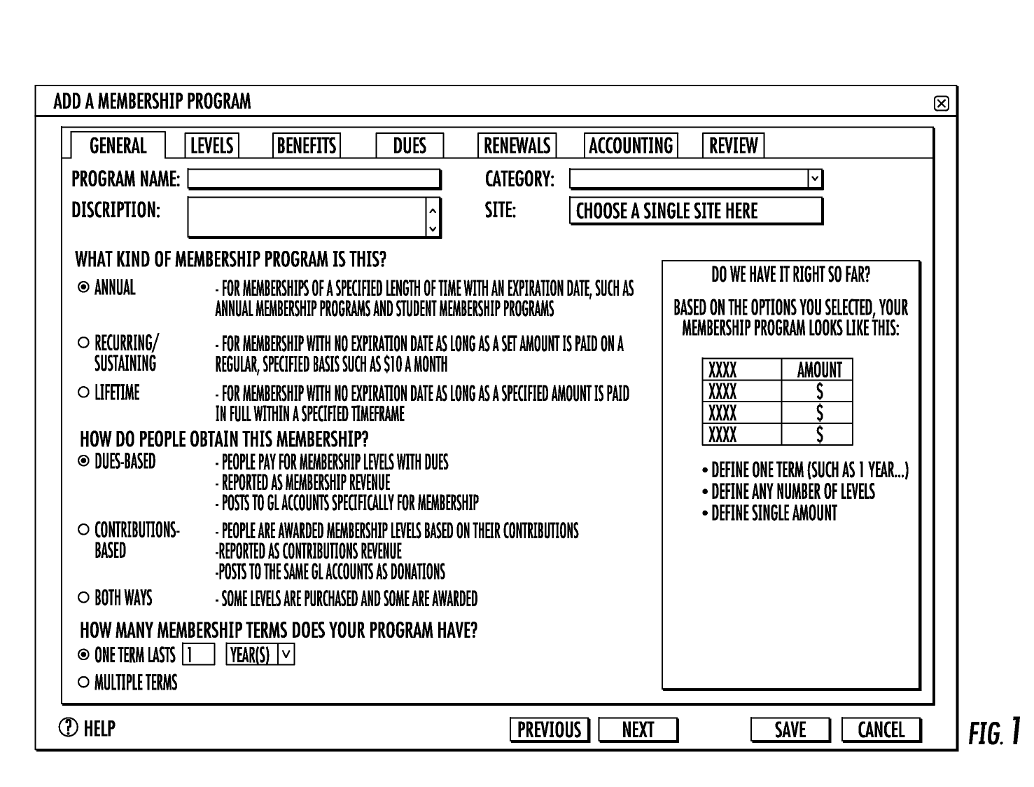

Referring now to FIG. 1, FIG. 1 presents an exemplary user interface for adding or establishing a membership program. In one embodiment, the user may enter a program name and a description for the program. Additionally, the user may select a category (e.g., from a drop-down list) for the program and a site for the program.

Additionally, the user is queried as to whether the membership program is annual, recurring/sustaining, or lifetime. The user is further queried as to whether the membership is dues-based, contribution-based, or both dues-based and contribution-based. The user may further be queried as to whether the membership has one term lasting for a specific period of time or multiple distinct terms, each distinct term lasting for a specific period of time. Additionally, each of the multiple distinct terms may run continuously or be separated by time gaps, wherein the duration of the time gaps may be specified by the user.

As indicated in FIG. 1, an annual membership is a membership with a specified length of time that has an expiration date. A recurring/sustaining membership is a membership with no expiration date as long as a set amount is paid on a regular, specified basis (e.g., $10/month). A lifetime membership has no expiration date as long as a specified amount is paid in full within a specified timeframe.

As indicated in FIG. 1, a dues-based membership is when people pay for membership levels with dues. The revenue from dues-based memberships is reported as membership revenue. A contribution-based membership is when people are awarded membership levels based on their contributions. The revenue from contribution-based memberships is reported as contributions revenue. A “both ways” membership is when some membership levels are purchased and other membership levels are awarded.

For a contribution-based membership model, the user may establish attributes or thresholds of contribution. These attributes or threshold may also be referred to as “conditions.” A system described herein may compare a person's or entity's (e.g., a member or prospective member in a pre-existing database) attributes or amounts of contribution during a predetermined period of time against the established attributes or thresholds of contribution. In response to determining that the person's attributes or levels of contribution substantially match the established attributes or thresholds, the person may be inducted into the membership program or the member may achieve a certain level in the membership program. For a dues-based membership model, an assumption is that there are no participants in the membership program at the inception of the membership program.

Additionally, as indicated in FIG. 1, the user may define levels, benefits, dues, renewals, etc. associated with a created membership program. For example, a user may define a membership program to have three distinct levels (e.g., gold, silver, bronze, etc.), each level being associated with a different amount of dues or contributions. The system may also permit the user to assign customized names for each level. The user may define the conditions (e.g., attributes, contribution or dues threshold, etc.) that need to be satisfied by a member in order to progress from a lower level to a higher level. Therefore, for example, a member may progress from a lower level to a higher level by making a dues payment or a contribution depending on the type of membership program. As a further example, the user may assign benefits for each level. A level associated with a higher amount of dues or contributions may offer more benefits to a member compared to a level associated with a lower amount of dues or contributions. Therefore, the user may define the type of benefits, the number of benefits, and the frequency of a benefit (e.g., twice during a membership term) that apply to each level.

As a further example, the user may define the maximum number of members that are allowed to be associated with a membership account, and a maximum number of membership cards that may be issued for a membership account. The maximum number of members allowed to be associated with a membership account may be the same as or different from the maximum number of membership cards that may be issued for a membership account.

As a further example, the user may define a window of time for renewing membership, wherein the window of time may run from prior to the membership expiration date to the expiration date or to a predetermined time period after the expiration date. Additionally, the user may define communication methods for different purposes and for different categories of members. For example, the user may define the communication method for sending a renewal notice to a member based on the highest level achieved by or awarded to the member. Additionally, the user may define what happens when a member renews a membership after the renewal period expires. For example, the user may define whether the member can reclaim benefits or levels associated with the member's expired membership account.

As a further example, the user may define add-ons associated with a membership program. For example, a user may receive one or more benefits (e.g., upgrade in level, parking pass, etc.) for payment of a fee. The user may establish the fee amount for each add-on.

Embodiments of the invention are also directed to providing an efficient data entry process, wherein at least a portion of the data entry is automated. The data entered into the system described herein is then accessible for purposes of audit, reconciling and creating deposits of transactions. A transaction may refer to any process associated with the system described herein.

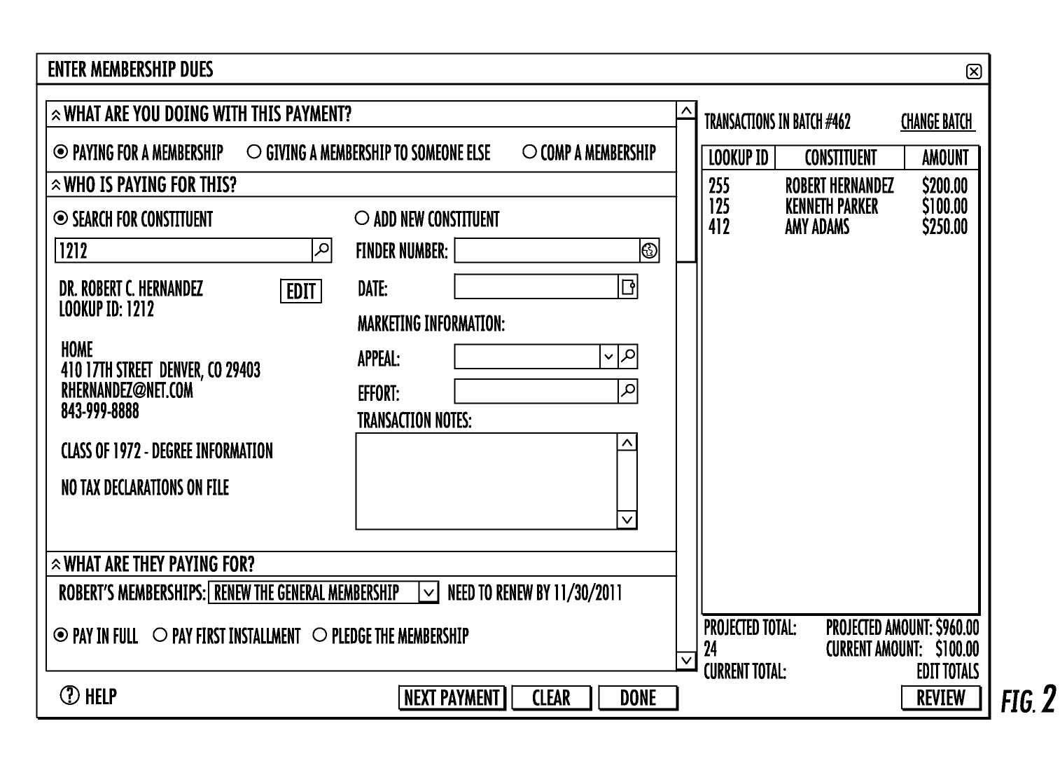

Referring now to FIG. 2, FIG. 2 presents another exemplary user interface. This user interface may allow a user to input membership dues (or process a payment associated with a membership account). This user interface shows that the user can either pay for a membership, give the membership to someone else, or comp a membership. Additionally, the user can specify who is paying for the membership. If the person or organization paying for the membership is an existing person or organization, the user may search for the person or organization, and select a particular person or organization. Alternatively, the user may add a new person or organization that will pay for the membership. Additionally, the user may specify what the payment is for, i.e., the purpose of the payment. For example, the payment may be a payment for renewing a membership. Additionally, the user may specify whether the payment is a: payment for the entire duration of membership, payment for a first installment of the total payment amount for the duration of membership, or a payment associated with an installment plan (e.g., associated with creating the installment plan) for the membership. Additionally, as indicated on the user interface in FIG. 2, the user is provided with options for clearing any inputted information, moving to a next payment, etc. Additionally, the user interface displays a list of transactions in batch of transactions that is currently being processed. Additionally, the user interface presents the total amount associated with the list of transactions.

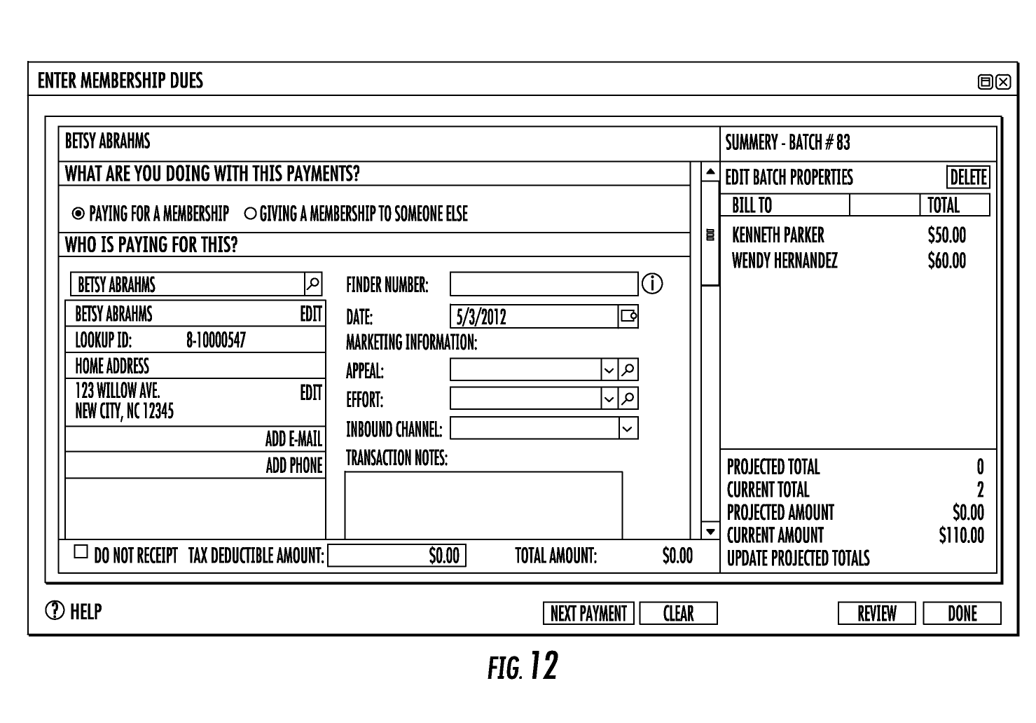

Referring now to FIG. 12, FIG. 12 presents another exemplary user interface. This user interface allows a user to input membership dues (or process a payment associated with a membership account). The features in FIG. 12 are described with respect to the other user interfaces presented herein.

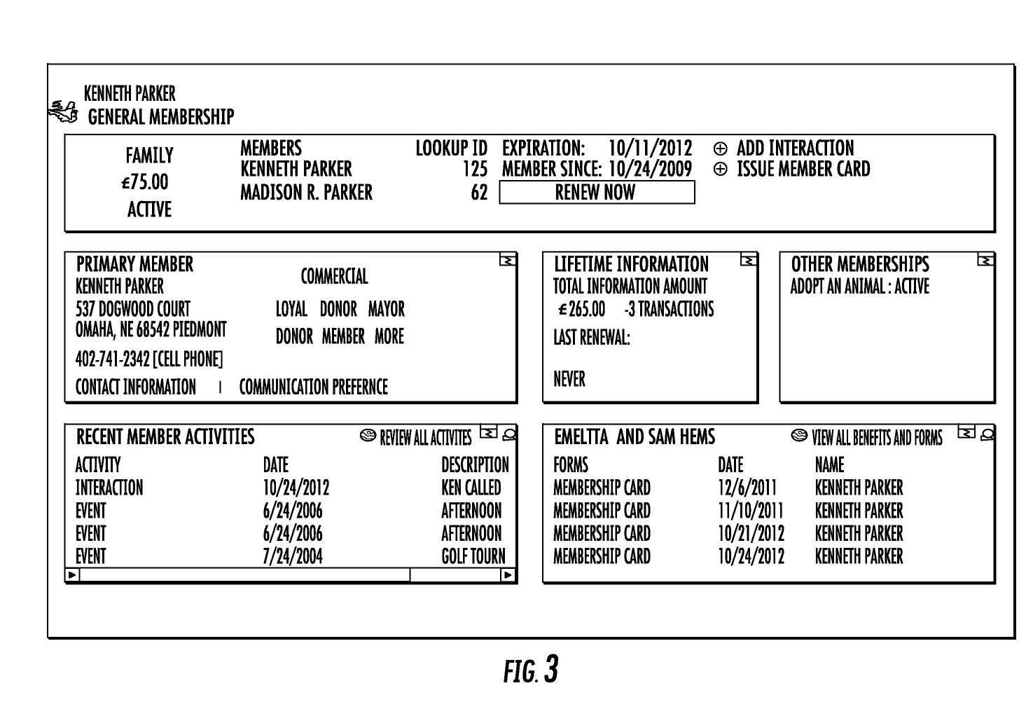

Referring now to FIG. 3, FIG. 3 presents an interface that allows a user or a member to view information associated with a membership. For example, as presented in FIG. 3, the interface page displays a family membership associated with a particular member. The interface page displays the payment amount for the memberships and indicates that the membership is active. Additionally, the interface page lists the names of persons that are members listed for the membership account. Additionally, the interface page lists the starting date and the expiration date for the membership. Additionally, the interface page lists the name and address of the primary member on the account. Additionally, the interface page lists constituencies associated with the membership account. Additionally, the interface page lists recent activities associated with the membership account. Additionally, the interface page lists lifetime membership contributions associated with the account. For example, the interface page may list the largest (and/or smallest) contribution or dues payment made by the member during a predetermined time period (e.g., a membership term) in the past. Additionally, the interface page may allow the user to view the fair market value of the membership if a portion of the membership is considered tax deductible. Additionally, the interface page lists other memberships associated with the members listed on the membership account. Additionally, the interface page lists benefits (e.g., membership cards) received by the members on the membership account. Additionally, the interface page lists contact information and communication preferences associated with the membership account. Additionally, the interface page presents options to renew the membership, add an interaction, issue a membership card, etc.

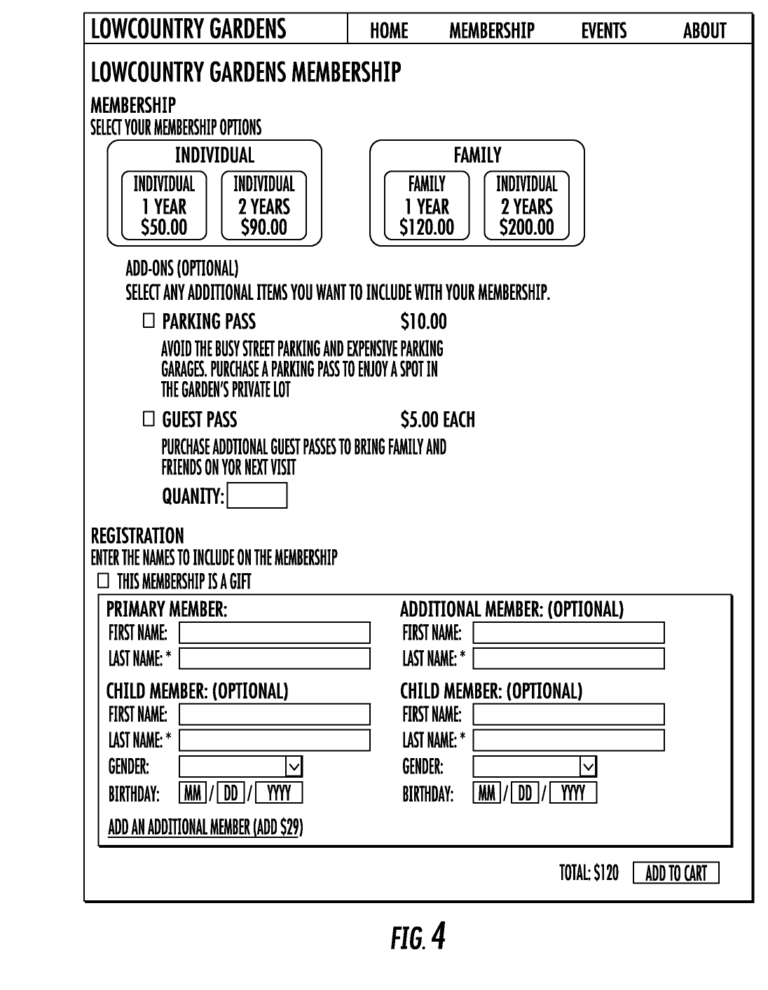

Referring now to FIG. 4, FIG. 4 provides members of the membership program with the ability to purchase and track a membership electronically via a network. In some embodiments, a prospective member may access a membership interface page as displayed in FIG. 4 and directly enter input onto the interface page. In other embodiments, the interface page may be accessed by a user of the system described herein, and the user enters input onto the interface page based on information received from the prospective member. Therefore, the prospective member may select a type of membership (e.g., an individual membership, a family membership, etc.). Additionally, the prospective member may select a duration of the membership (e.g., one year, two years, etc.). Additionally, the prospective member may select one or more add-ons (e.g., a parking pass, guest pass, etc.). Additionally, the prospective member may select a “gift” option to indicate that the prospective member intends to gift the membership to someone else. Additionally, the prospective member may input the name of the prospective member along with the names and other profile details (e.g., gender, date of birth, etc.) of other people (adults and/or children) to include in the membership. Additionally, the user may select an option to add extra members by paying a fee.

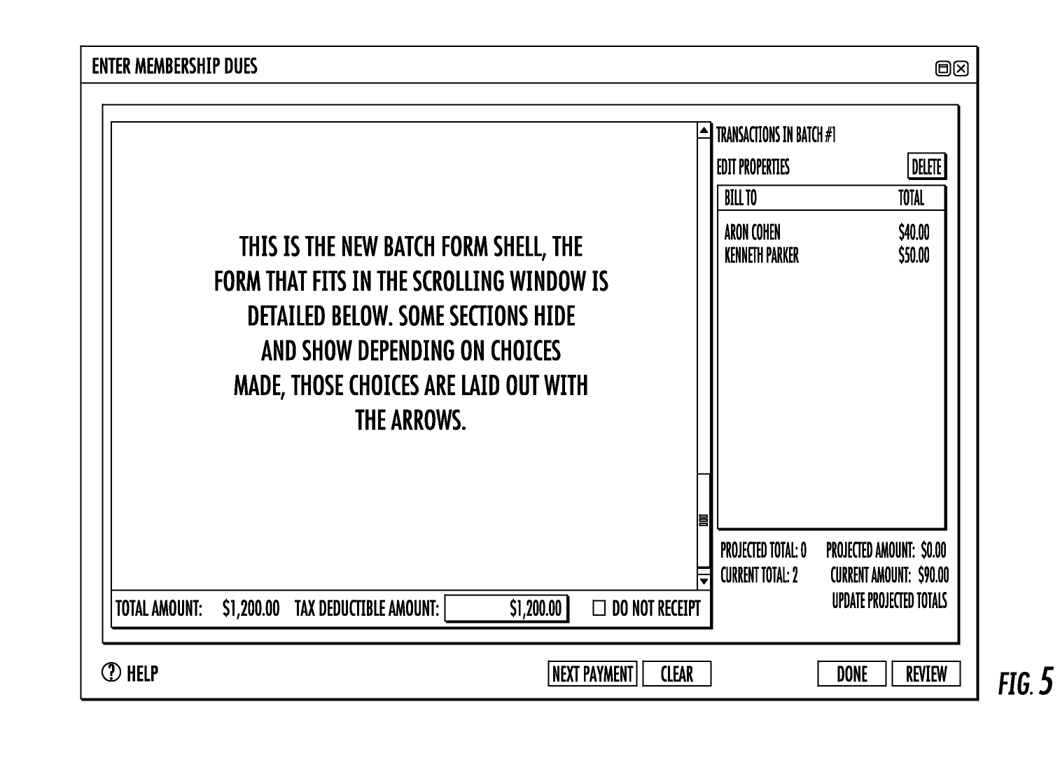

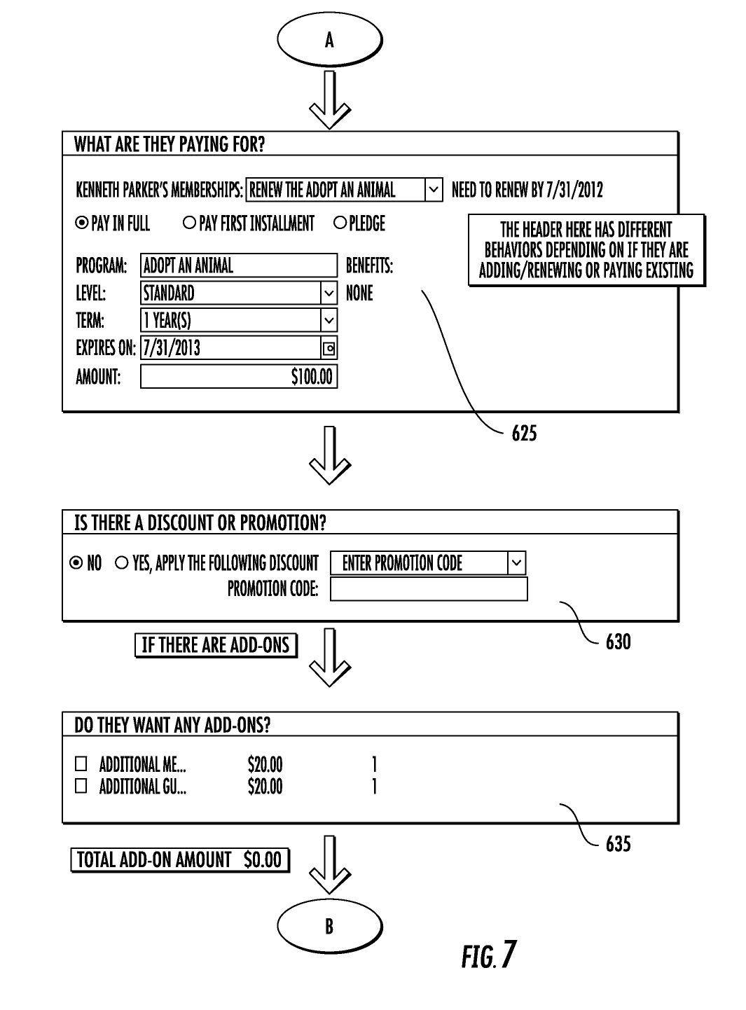

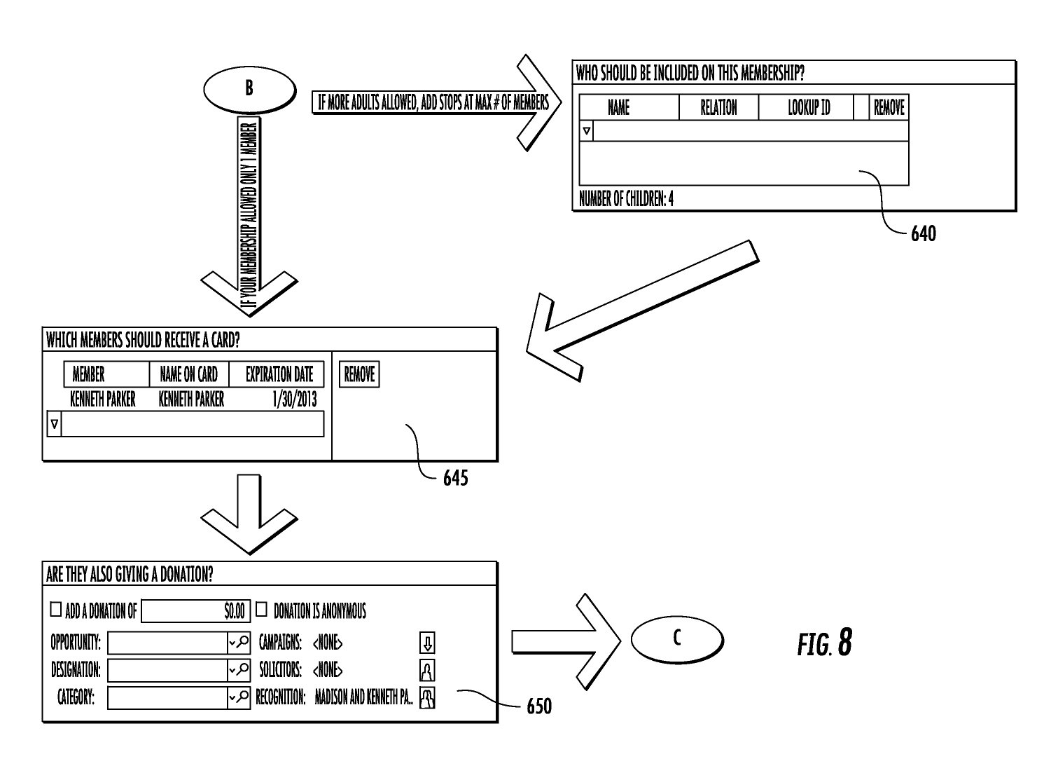

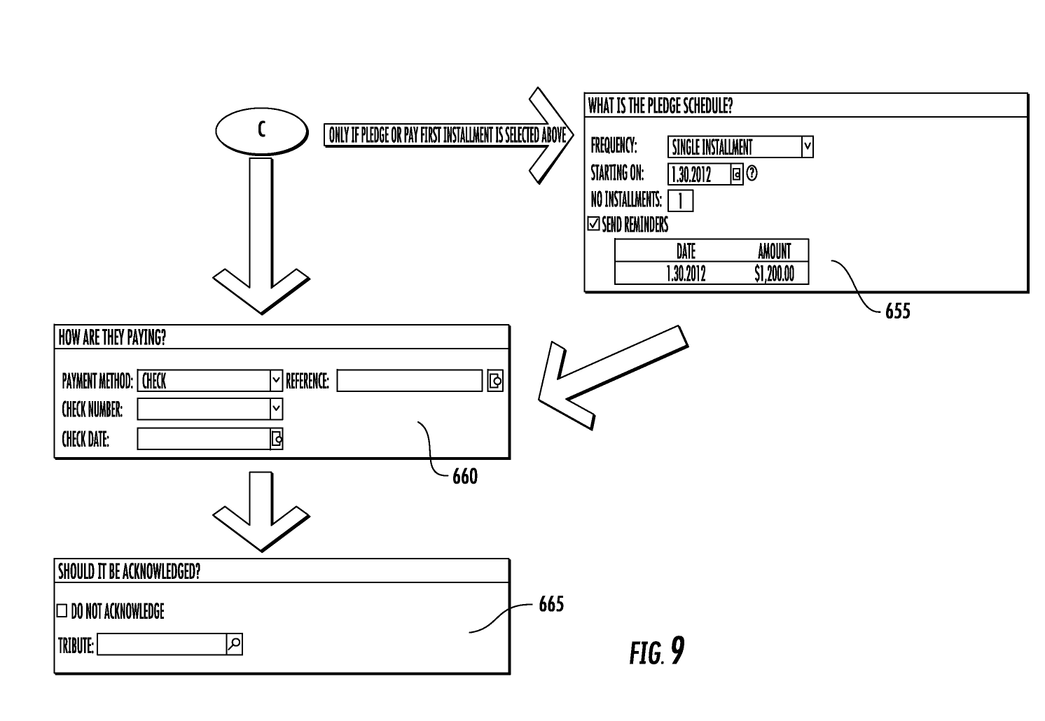

Referring now to FIG. 5-11, FIGS. 5-11 presents user interfaces associated with processing of membership dues. In FIG. 5, the user may enter a payment amount that is due. The user may also indicate whether the user wants to create a receipt for the transaction. Additionally, the user may also view a list of other transactions in a batch of transactions.

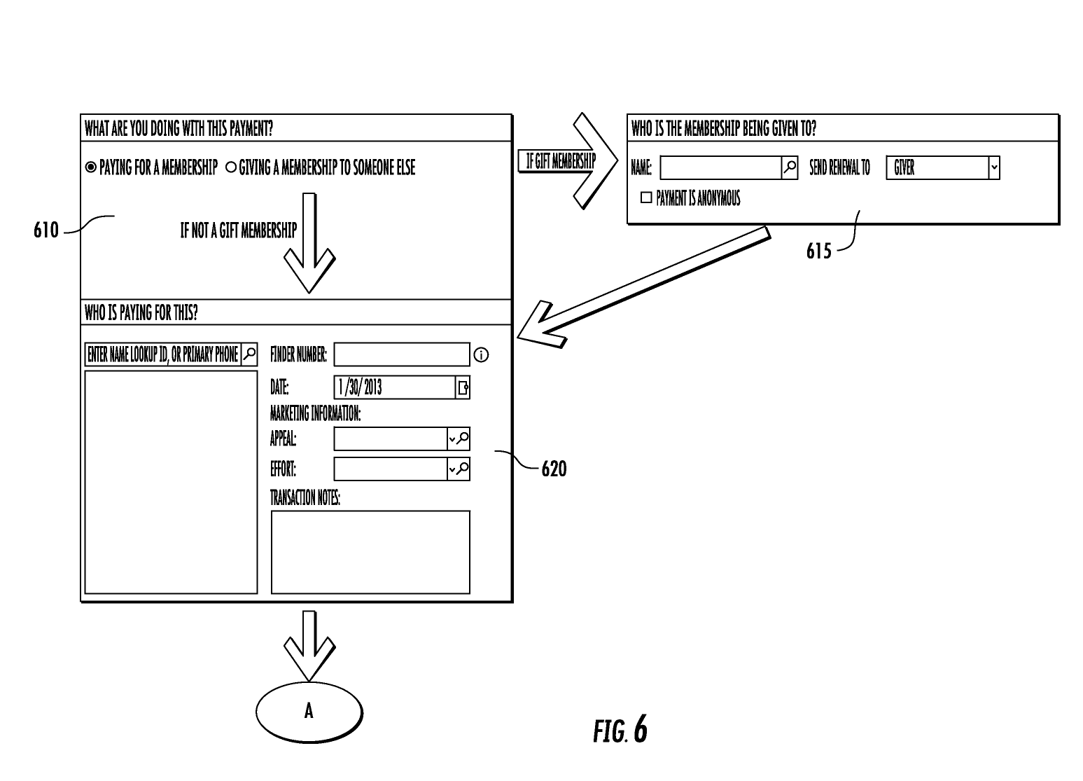

FIGS. 6-9 present steps of a process flow for processing a payment. The payment may either be processed individually or may be processed together with a batch of other payments made during a predetermined period of time (e.g., the previous twenty-four hours). In some embodiments, a batch file comprising multiple payment may be viewed in a database grid format. In some embodiments, after executing the steps of the process flow presented in FIGS. 6-9, the system enables a user to review the inputted information in order to check for any errors or inconsistencies in the user input. In some embodiments, the system may conduct an automatic review process, and present any errors or inconsistencies to the user.

At block 610, the user selects whether the payment is for a membership or whether the user intends to give the membership to someone else. If the user intends to give the membership to someone else (e.g., if the membership is a gift membership), at block 615, the user may indicate the name of the person who the membership is being given to. Additionally, the user may specify who needs to be billed for a renewal amount for renewing the membership in the future. For example, the user may specify that the person gifting the membership is responsible for paying the renewal amount.

At block 620, the user may include the details of the person or organization (e.g., the payor) that will pay for the membership. The user may enter at least one of the name of the person or organization, a lookup identification (ID) number associated with the person or organization, or a phone number associated with the name or organization. In some embodiments, receiving input of at least one piece of information (e.g., name, lookup ID number, phone number, etc.) causes the system to search for a person or organization associated with the input. Personal information such as address, email address, and phone number is viewable and editable.

Additionally, at block 625, the user needs to indicate what the payment is for, i.e., the purpose of the payment. For example, as indicated at block 625, the payment may be for renewing a membership. In some embodiments, the user interface indicates a last date to renew the membership. Additionally, as indicated in the user interface associated with block 625, the user may indicate the name of the membership program for which the payment is being made, a level associated with the program, a term, and an amount. The expiration field may be automatically populated based on the term selected by the user. Additionally, the user may indicate whether the user wants to pay the full amount of the membership, pay the first installment of the membership amount, or make a payment associated with an installment plan (e.g., a payment for setting up an installment plan) for the membership. In some embodiments, the option to pay the full amount of the membership may be used only once per membership term.

At block 630, the user indicates whether a discount is applied to the payment. If a discount is being applied to the payment, the user may enter a promotion code into the text field or select from a list of discounts associated with the selected program.

At block 635, the user indicates whether any add-ons are applicable. Add-ons may include additional members to be associated with the membership account, guests to be associated with the membership account, etc. The user interface may indicate the payment amount or fee associated with each add-on. The user interface may allow specifying the number of add-ons to allocate with the membership account.

If more than one person is allowed to be included on the membership account, at block 640, the user may specify details of the other persons (or organizations) to be included on the membership account. These details may include at least one of the name of, relation of, and a look-up ID associated with the at least one other person. The other person or organization may also be referred to as a secondary member. In some embodiments, the system prevents a user from adding more than a predetermined number of additional members on a membership account.

Additionally, at block 645, the user may specify which members on the account should receive a membership card. When the membership program permits only one member per account, only that member receives a membership card. The user may indicate the name to be displayed on the card, which name may be different from the member's real name. Additionally, the user may specify an expiration date associated with the membership card, which date may be different from the expiration date associated with the membership account. The maximum number of membership cards that are allowed on a single membership account may be the same as or different from the maximum number of members allowed on the single membership account.

At block 650, the user indicates whether the member is making or giving a donation. The user may indicate the amount of the donation. The user may also specify at least one of an opportunity, designation, or category associated with the donation.

At block 655, the user indicates the installment plan schedule associated with the donation. For example, the user may specify the frequency of the installment plan (e.g., single installment, multiple installments, etc.), when the installment plan schedule starts, and the number of installments associated with the installment plan. Additionally, the user may indicate whether an automatic installment plan reminder should be sent to the member a predetermined time period before the installment plan amount is due. Block 655 is executed only if the user selected “installment plan” or “pay first installment” at block 625.

At block 660, the user indicates the mode of payment (e.g., check, cash, payment card, etc.). If the mode of payment is via check, the user may input a check number and a check date.

At block 665, the user indicates whether the payment should be acknowledged. Additionally, the user may indicate that the user intends to keep the payment anonymous (e.g., the person or organizing receiving the membership does not know who made the payment). After the completion of the process, the system may move to the next payment in a batch of payments. Alternatively, in some embodiments, one or more payments in a batch may be processed simultaneously.

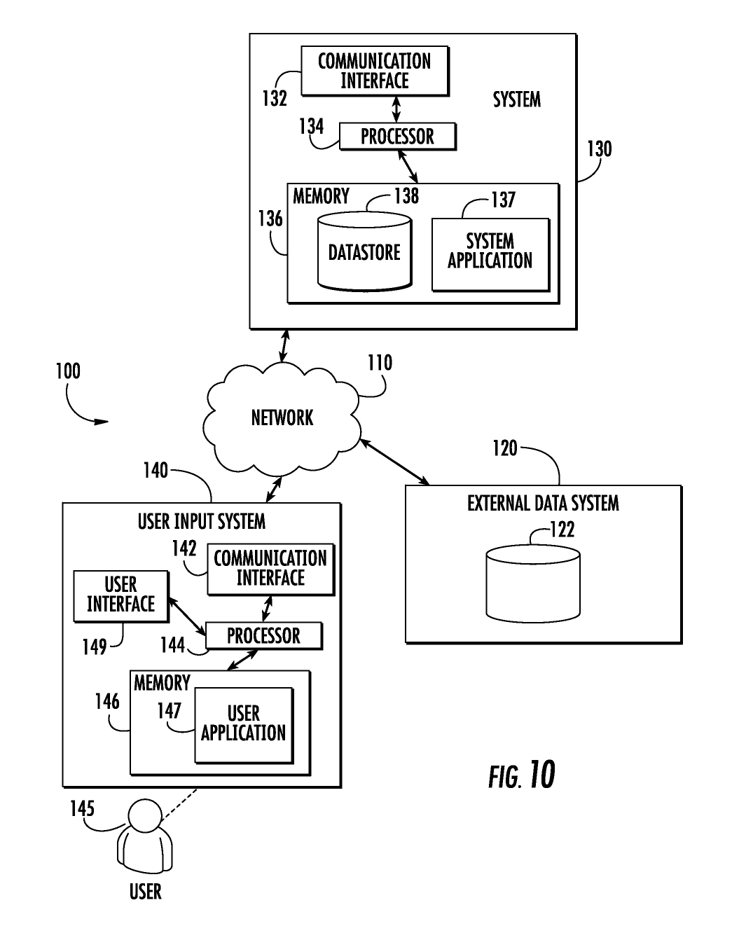

Referring now to FIG. 10, FIG. 10 presents an exemplary block diagram of the system environment 100 for managing membership programs and for executing various processes associated with membership programs, in accordance with embodiments of the present invention. As illustrated, the system environment 100 includes a network 110, an external data system 120, a system 130, and a user input system 140. Also shown in FIG. 10 is a user 145 of the user input system 140.

As shown in FIG. 10, the external data system 120, the system 130, and the user input system 140 are each operatively and selectively connected to the network 110, which may include one or more separate networks. In addition, the network 110 may include a local area network (LAN), a wide area network (WAN), and/or a global area network (GAN), such as the Internet. It will also be understood that the network 110 may be secure and/or unsecure and may also include wireless and/or wireline and/or optical interconnection technology.

The external data system 120 may be any computing or non-computing system that transmits data to the system 130. Additionally or alternatively, data from the system 130 may be transmitted to the external data system 120. As presented in FIG. 10, the external data system 120 comprises at least one datastore 122.

The user input system 140 may include any computerized apparatus that can be configured to perform any one or more of the functions of the user input system 140 described and/or contemplated herein. For example, the user 145 may use the user input system 140 to transmit data to the system 130. In some embodiments, for example, the user input system 140 may include a personal computer system, a mobile computing device, a personal digital assistant, a network device, and/or the like. As illustrated in FIG. 10, in accordance with some embodiments of the present invention, the user input system 140 includes a communication interface 142, a processor 144, a memory 146 having a user application 147 stored therein, and a user interface 149. In such embodiments, the communication interface 142 is operatively and selectively connected to the processor 144, which is operatively and selectively connected to the user interface 149 and the memory 146. In some embodiments, the user 145 may use the user application 147 to execute processes described with respect to the user interfaces and process flows described herein (e.g., the process for establishing a membership program, the process for processing a payment associated with a membership account, etc.).

Each communication interface described herein, including the communication interface 142, generally includes hardware, and, in some instances, software, that enables the user input system 140, to transport, send, receive, and/or otherwise communicate information to and/or from the communication interface of one or more other systems on the network 110. For example, the communication interface 142 of the user input system 140 may include a modem, server, electrical connection, and/or other electronic device that operatively connects the user input system 140 to another system such as the system 130.

Each processor described herein, including the processor 144, generally includes circuitry for implementing the audio, visual, and/or logic functions of the user input system 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 147 of the memory 146 of the user input system 140.

Each memory device described herein, including the memory 146 for storing the user application 147 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 10, the memory 146 includes the user application 147. In some embodiments, the user application 147 includes an interface for communicating with, navigating, controlling, configuring, and/or using at least one of the system 130 or the user input system 140. In some embodiments, the user application 147 includes computer-executable program code portions for instructing the processor 144 to perform one or more of the functions of the user application 147 described and/or contemplated herein. In some embodiments, the user application 147 may include and/or use one or more network and/or system communication protocols.

Also shown in FIG. 10 is the user interface 149. In some embodiments, the user interface 149 includes one or more user output devices, such as a display and/or speaker, for presenting information to the user 145 and/or some other user. In some embodiments, the user interface 149 includes one or more user input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 145 and/or some other user. In some embodiments, the user interface 149 includes the input and display devices of a personal computer, such as a keyboard and monitor, which are operable to receive and display information.

FIG. 10 also illustrates a system 130, in accordance with an embodiment of the present invention. The system 130 may include any computerized apparatus that can be configured to perform any one or more of the functions of the system 130 described and/or contemplated herein. In accordance with some embodiments, for example, the system 130 may include a computer network, an engine, a platform, a server, a database system, a front end system, a back end system, a personal computer system, and/or the like. In some embodiments, such as the one illustrated in FIG. 10, the system 130 includes a communication interface 132, a processor 134, and a memory 136, which includes a system application 137 and a datastore 138 stored therein. As shown, the communication interface 132 is operatively and selectively connected to the processor 134, which is operatively and selectively connected to the memory 136. The system application 137 may perform functions associated with membership data (e.g., data associated with members, membership programs, payments associated with a membership account, etc.). The data may be received either directly from a member or from a user (e.g., user 145).

It will be understood that the system application 137 may be configured to implement any one or more portions of the various user interfaces and/or process flow described herein. It will also be understood that, in some embodiments, the memory includes other applications. It will also be understood that, in some embodiments, the system application 137 is configured to communicate with the datastore 138, the user input system 140 and/or the external data system 120.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols.

In addition to the system application 137, the memory 136 also includes the datastore 138. As used herein, the datastore 138 may be one or more distinct and/or remote datastores. In some embodiments, the datastore 138 is not located within the system and is instead located remotely from the system. In some embodiments, the datastore 138 stores information or data described herein. For example, the datastore 138 stores the pre-existing data (e.g., associated with donors or contributors) described herein.

It will be understood that the datastore 138 may include any one or more storage devices, including, but not limited to, datastores, databases, and/or any of the other storage devices typically associated with a computer system. It will also be understood that the datastore 138 may store information in any known way, such as, for example, by using one or more computer codes and/or languages, alphanumeric character strings, data sets, figures, tables, charts, links, documents, and/or the like. Further, in some embodiments, the datastore 138 may include information (e.g., membership information) associated with one or more applications, such as, for example, the system application 137. It will also be understood that, in some embodiments, the datastore 138 provides a substantially real-time representation of the information stored therein, so that, for example, when the processor 134 accesses the datastore 138, the information stored therein is current or substantially current.

It will be understood that the embodiment of the system environment illustrated in FIG. 10 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

In addition, the various portions of the system environment 100 may be maintained for and/or by the same or separate parties. For example, the system 130 and the external data system 120 may be maintained by separate parties.

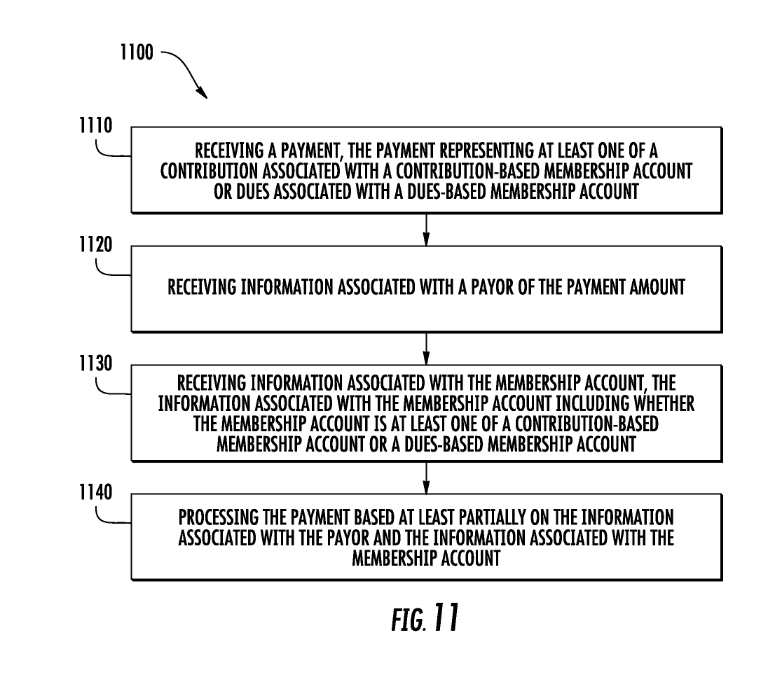

It will also be understood that the system 130 may include and/or implement any embodiment of the present invention described and/or contemplated herein. For example, in some embodiments, the system 130 is configured to implement any one or more of the embodiments of the process flow 1100 described and/or contemplated herein in connection with FIG. 11, or any other process flow described herein (e.g., the process for establishing a membership program).

Referring now to FIG. 11, FIG. 11 is an exemplary process flow 1100 for processing a payment associated with a membership account, in accordance with embodiments of the present invention. In some embodiments, the process flow may include less or more steps than those presented in FIG. 11. Additionally, the steps of the process flow may be performed in an order different from that presented in FIG. 11. At block 1110, the process flow comprises receiving a payment, the payment representing at least one of a contribution associated with a contribution-based membership account or dues associated with a dues-based membership account. At block 1120, the process flow comprises receiving information associated with a payor of the payment amount. At block 1130, the process flow comprises receiving information associated with the membership account, the information associated with the membership account including whether the membership account is at least one of a contribution-based membership account or a dues-based membership account. At block 1140, the process flow comprises processing the payment based at least partially on the information associated with the payor and the information associated with the membership account.

In accordance with embodiments of the invention, the term “module” with respect to a system (or a device) may refer to a hardware component of the system, a software component of the system, or a component of the system that includes both hardware and software. As used herein, a module may include one or more modules, where each module may reside in separate pieces of hardware or software.

In some embodiments, the methods described herein may be automatically configured to run periodically. As used herein, the term “automatic” refers to a function, a process, a method, or any part thereof, which is executed by computer software upon occurrence of an event or a condition without intervention by a user.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method for processing a payment associated with a membership account, the method comprising:
receiving a payment, the payment representing at least one of a contribution associated with a contribution-based membership account or dues associated with a dues-based membership account;
receiving information associated with a payor of the payment amount;
receiving information associated with the membership account, the information associated with the membership account comprising whether the membership account is at least one of a contribution-based membership account or a dues-based membership account; and
processing the payment based at least partially on the information associated with the payor and the information associated with the membership account.

2. The method of claim 1, wherein the information associated with the membership account further comprises at least one of a name, a level, a term, or an expiration date.

3. The method of claim 1, wherein the payment amount is for at least one of a full payment for an entire term of the membership account, a first installment of the full payment, or a payment associated with an installment plan.

4. The method of claim 3, wherein in response to the payment amount being a first installment or a payment associated with an installment plan, receiving an installment plan schedule, the installment plan schedule comprising a frequency, a start date, and a number of installments.

5. The method of claim 1, wherein the payment amount is a renewal amount.

6. The method of claim 1, further comprising:
receiving selection of whether the membership account is a gift membership account; and
in response to determining the membership account is a gift membership account, receiving information associated with an entity or person receiving the gift membership account.

7. The method of claim 1, wherein the membership program is at least one of an annual program, a recurring program, or a lifetime program.

8. The method of claim 1, wherein the processing step further comprises applying a discount to the payment amount.

9. The method of claim 1, further comprising receiving at least one add-on, and wherein the processing step further comprises processing the payment based at least partially on the add-on.

10. The method of claim 1, further comprising:
receiving information associated with at least one member to be included in the membership account, wherein the processing step further comprises processing the step based on the received information; and
preventing inclusion of more than a predetermined number of members to the membership account.

11. The method of claim 1, further comprising:
receiving selection of which members on the membership account should receive a membership card.

12. The method of claim 1, further comprising:
receiving information regarding whether a member associated with the membership account is making a donation.

13. The method of claim 1, further comprising:
receiving selection of a payment method, and wherein the processing step further comprises processing the payment based on the payment method.

14. The method of claim 1, further comprising:
receiving selection of whether the payment should be acknowledged or whether the payor intends to remain anonymous.

15. A system for processing a payment associated with a membership account, the system comprising:
a memory;
a processor;
a module stored in the memory, executable by the processor, and configured to:
receive a payment, the payment representing at least one of a contribution associated with a contribution-based membership account or dues associated with a dues-based membership account;
receive information associated with a payor of the payment amount;
receive information associated with the membership account, the information associated with the membership account including whether the membership account is at least one of a contribution-based membership account or a dues-based membership account; and
process the payment based at least partially on the information associated with the payor and the information associated with the membership account.

16. A method for establishing a membership program, the method comprising:
receiving selection of whether the membership program is annual, recurring, or lifetime;
receiving selection of whether the membership program is dues-based, contribution-based, or both dues-based and contribution-based;
receiving selection of whether the membership program has a single term or multiple terms; and
receiving selection of at least one level associated with the membership program, wherein a dues-based membership program is program where a member makes a payment to achieve a level associated with the program, and
wherein a contribution-based membership program is a program where a member is awarded a level associated with the program based on the member's amount of contribution.

17. The method of claim 16, further comprising receiving selection of at least one benefit associated with the at least one level.

18. The method of claim 16, further comprising receiving an expiration date associated with a renewal period for renewing a membership account associated with the membership program when the membership program is a recurring program.

19. The method of claim 16, receiving selection of at least one condition for achieving the at least one level associated with the membership program, wherein the at least one condition includes an amount of dues or contribution to achieve or be awarded the at least one level.

20. The method of claim 16, wherein when the membership program is contribution-based, a pre-existing database of contributors can be inducted into the membership program based at least partially on whether a contributor in the pre-existing database satisfies at least one condition associated with being awarded the at least one level.
